(19) United States
(12) Patent Application Publication
(10) Pub. No.: US 2018/0078801 A1
(43) Pub. Date: Mar. 22, 2018

(54) FIRE-SUPPRESSION SYSTEM AND METHOD

(71) Applicant: Paul Perkovich, Port Hardy (CA)

(72) Inventor: Paul Perkovich, Port Hardy (CA)

(21) Appl. No.: 15/268,323

(22) Filed: Sep. 16, 2016

(51) Int. Cl. A62C 3/02; A62C 35/68

(52) U.S. Cl. CPC A62C 3/02; A62C 35/68

(57) ABSTRACT

A fire-suppression system configured to provide protection of a roof surface of a building using water or other fire-extinguishing agent. A set of roof-mounted sprinklers disperse water or other fire-extinguishing agent on the roof surface. The system automatically drains the fire-extinguishing agent from the system when the system deactivates. A pre-assembled roof-flashing assembly is also disclosed.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of fluid sprinkling, spraying, and diffusing building features and more specifically relates to a fire-suppression system.

### 2. Description of Related Art

This invention responds to a changing Earth climate that is contributing to an increase in the frequency of large-scale forest fires. These fires are now becoming the norm rather than the extreme. It is common in such events for thermal convection currents to carry flaming debris well beyond the burn zone to deposit on roof surfaces of adjacent buildings. Many structures burn to the ground when this flaming debris ignites combustible roof materials or accumulations of leaves or needles on roof surface. Thus, many buildings are at risk even when located outside the direct path of fire event.

Several attempts have been made to solve the above-mentioned problems such as those found in the following references: U.S. Pat. No. 7,886,837 to Helfgott; U.S. Pat. No. 6,964,379 to Crowley; U.S. Pat. No. 7,673,696 to Gunn; U.S. Pat. No. 5,263,543 to Nigro; U.S. Pat. No. 6,450,264 to Christian; U.S. Pat. No. 8,893,814 to Bui; U.S. Pat. No. 6,629,569 to Adams; U.S. Pat. No. 5,732,511 to Scott; U.S. Pat. No. 6,824,073 to Haney; U.S. Pat. No. 9,084,907 to Kornhaber; U.S. Pub. No. 2015/0238789 to Johnson et al.; U.S. Pub. No. 2011/0247842 to Huber; U.S. Pub. No. 2009/0090520 to Lee; U.S. Pub. No. 2008/0289830 to Olson; and U.S. Pub. No. 2009/0200044 to Durkin. This art is representative of fluid sprinkling, spraying, and diffusing building features. However, none of the above inventions and patents, taken either singly or in combination, is seen to describe the invention as claimed.

### BRIEF SUMMARY OF THE INVENTION

In view of the foregoing disadvantages inherent in the known fluid sprinkling, spraying, and diffusing building features art, the present invention provides a novel fire-suppression system. The general purpose of the present invention, which will be described subsequently in greater detail is to provide protection of a roof surface of a building using at least one fire-extinguishing fluid.

In accordance with a preferred embodiment hereof, this invention provides a fire-suppression system, relating to protection of a roof surface of a building using water or other fire-extinguishing agent, the fire-suppression system comprising a set of sprinklers to assist dispersal of the water on a portion of the roof surface, and in fluid communication with the set of sprinklers, at least one water-conducting pipe configured to conduct the water to the set of sprinklers. Additionally, it provides such a fire-suppression system wherein the at least one water-conducting pipe comprises a fluid coupler configured to operably couple the at least one water-conducting pipe with a pressurized source of the water, a discharge drain configured to enable draining of such water from a portion of the at least one water-conducting pipe, and a fluid control valve configured to control movement of the water between the fluid coupler, the set of sprinklers, and the discharge drain. Moreover, it provides such a fire-suppression system wherein the fluid control valve comprises a first user-selectable configuration and a second user-selectable configuration. More specifically, it provides such a system wherein the first user-selectable configuration of the fluid control valve enables movement of the water between the fluid coupler and the set of sprinklers while contemporaneously preventing draining of such water from the portion of the at least one water-conducting pipe through the discharge drain. Even further, it provides such a system wherein the second user-selectable configuration of the fluid control valve prevents movement of the water between the fluid coupler and the set of sprinklers while contemporaneously enabling draining of the water from the portion of the at least one water-conducting pipe through the discharge drain; wherein, when the fluid control valve is placed in the first user-selectable configuration, such dispersal of such water on such portion of such roof surface is enabled.

Additionally, it provides such a fire-suppression system wherein the fluid control valve comprises a manually-operable three-way valve. Furthermore, it provides such a fire-suppression system wherein the water-conducting pipe comprises a sloping geometry to enable gravity-assisted drainage of the water through the discharge drain when the fluid control valve is placed in such second user-selectable configuration. Moreover, it provides such a fire-suppression system wherein at least one sprinkler of the set of sprinklers is vented to atmosphere and wherein the water-conducting pipe, including the fluid control valve, are configured to place the at least one sprinkler in fluid communication with the discharge drain when the fluid control valve is placed in the second user-selectable configuration.

Additionally, it provides such a fire-suppression system wherein the water-conducting pipe comprises at least one material selected from steel, cast iron, copper, Chlorinated Polyvinyl Chloride, Polyvinyl Chloride, and Crosslinked Polyethylene. Also, it provides such a fire-suppression system wherein the set of sprinklers comprise at least one commercially-sourced sprinkler head.

In addition, the fire-suppression system further comprises interior-located system components located interior of the building and exterior-located system components located exterior of the building. Moreover, it provides such a fire-suppression system wherein at least the set of sprinklers comprise the exterior-located system components. Even further, it provides such a system wherein at least the water-conducting pipe comprises the interior-located system components.

In addition, the fire-suppression system further comprises a set of interior-to-exterior fluid couplers, each one configured to operably couple a respective interior-located system component with a respective the exterior-located system component. Further, it provides such a system wherein each interior-to-exterior fluid coupler comprises, a fluid-conducting pipe segment configured to conduct water through the roof surface, and joined integrally with and surrounding the fluid-conducting pipe segment, a flashing member having a base surface adapted to be attached and sealed to such roof surface to prevent moisture leakage therethrough. Moreover, it provides such a system wherein the base surface of the flashing member is adapted to be attached and sealed to a peak portion of the roof surface; wherein the interior-to-exterior fluid coupler comprises a factory applied finish.

Additionally, it provides such a fire-suppression system wherein the fluid-conducting pipe segment comprises an exterior-end coupler adapted to form a fluid-tight coupling with exterior-located system components and an interior-end coupler adapted to form a fluid-tight coupling with interior-located system components. Also, it provides such a fire-suppression system wherein the exterior-end coupler comprises a cylindrical wall having an internally-threaded bore. Even further, it provides such a fire-suppression system wherein the internally-threaded bore comprises an industry-standard female iron pipe thread configuration. Moreover, it provides such a fire-suppression system wherein the interior-end coupler is adapted to receive an industry-standard pipe-fitting.

Even further, it provides such a fire-suppression system further comprising a kit including; the set of sprinklers, the set of interior-to-exterior fluid couplers, the water-conducting pipe including the fluid control valve and the discharge drain, and a set of user instructions.

In accordance with another preferred embodiment hereof, this invention provides a method of using a fire-suppression system, relating to protection of a roof surface of a building using at least one fire-extinguishing fluid, the method comprising the steps of providing a set of sprinklers, providing a set of interior-to-exterior fluid couplers, each one including a fluid-conducting pipe segment to conduct such at least one fire-extinguishing fluid through the roof surface, and joined integrally with and surrounding the fluid-conducting pipe segment, a flashing member having a base surface adapted to be attached and sealed to the roof surface to prevent moisture leakage therethrough. In addition, it provides such a method of using a fire-suppression system further comprising the step of providing a set of fluid-conducting pipes including a discharge drain, and a three-way fluid control valve adapted to activate the system and automatically drain such at least one fire-extinguishing fluid from the set of fluid-conducting pipes on deactivation of the system.

Furthermore, it provides such a method of using a fire-suppression system further comprising the steps of mounting such interior-to-exterior fluid couplers to the roof surface, coupling the set of sprinklers to such interior-to-exterior fluid couplers, and coupling such set of water-conducting pipes to the interior-to-exterior fluid couplers and to a pressurized source of the at least one fire-extinguishing fluid. Whereby, protection of the roof surface of the building using the at least one fire-extinguishing fluid is provided. Even further, it provides such a method of a fire-suppression system further comprising the steps of installing the set of water-conducting pipe within an interior of the building, installing the set of water-conducting pipe to enable the at least one fire-extinguishing fluid from at least one portion of the set of water-conducting pipe, and installing the three-way fluid control valve in a user accessible location.

The present invention holds significant improvements and serves as a fire-suppression system. Preferably, fluid sprinkling, spraying, and diffusing building features should provide protection of a roof surface of a building using at least one fire-extinguishing fluid and, yet would operate reliably and be manufactured at a modest expense. Thus, a need exists for a reliable fire-suppression system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, a fire-suppression system, constructed and operative according to the teachings of the present disclosure.

FIG. 1 shows a diagrammatic perspective view, illustrating a fire-suppression system during an ‘in-use’ condition, according to an embodiment of the disclosure.

FIG. 2 is a diagram, further illustrating the fire-suppression system as operably incorporated in a building, according to an embodiment of the present invention of the disclosure.

FIG. 3 is a diagram, illustrating a three-way valve of the fire-suppression system, adjusted to a first user-selectable configuration, according to an embodiment of the present disclosure.

FIG. 4 is a diagram, illustrating the three-way valve adjusted to a second user-selectable configuration, according to the embodiment of FIG. 1.

FIG. 5 is the detail section view 5 of FIG. 2, magnified for clarity, illustrating a pre-assembled interior-to-exterior fluid coupler and flashing assembly installed on a roof surface of the building, according to an embodiment of the present disclosure.

FIG. 6 shows a partially exploded perspective view, illustrating the pre-assembled interior-to-exterior fluid coupler and flashing assembly, according to the embodiment of FIG. 3.

FIG. 7 is a diagram, illustrating components of a kit, according to another preferred embodiment of the disclosure.

FIG. 8 is a flow diagram, illustrating a method of using the fire-suppression system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to the protection roof surfaces of a building or structure using at least one fire-extinguishing fluid and more particularly, to a fire-suppression system as used to improve the protection of a roof surface of a building using at least one fire-extinguishing fluid.

Generally speaking, the fire sprinkler system of the present disclosure functions to “soak down” the roof of the building with water or other fire-suppression agent to assist in preventing ignition of the building's roofing materials. The system is particularly useful during forest fires events when buildings frequently burn from an ignition point on the roof caused by flaming debris. The system is manually activated as fire threats occur and continues to operate after the property owner or occupants have been evacuated from the site.

The fire sprinkler system of the present disclosure is cost effective to install in both new buildings and existing structures. Key benefits of the present system include:
1) Once activated, the system continues to protect the building even when unattended.
2) Firefighting assets and other public-safety personnel are freed up to attend to more urgent matters.
3) Installation of the system is cost-effective in both new residential construction and in existing homes.
4) To prevent pipe leaks or failures due to freezing, the water or other fire-suppression agent is automatically purged from the sprinkler piping after deactivation; thus, the system is foolproof in its design features and significantly reduces issues related to human operational error.
5) The system fights the fire at the roof level, which is the most vulnerable area of the structure during a forest fire or similar fire event.

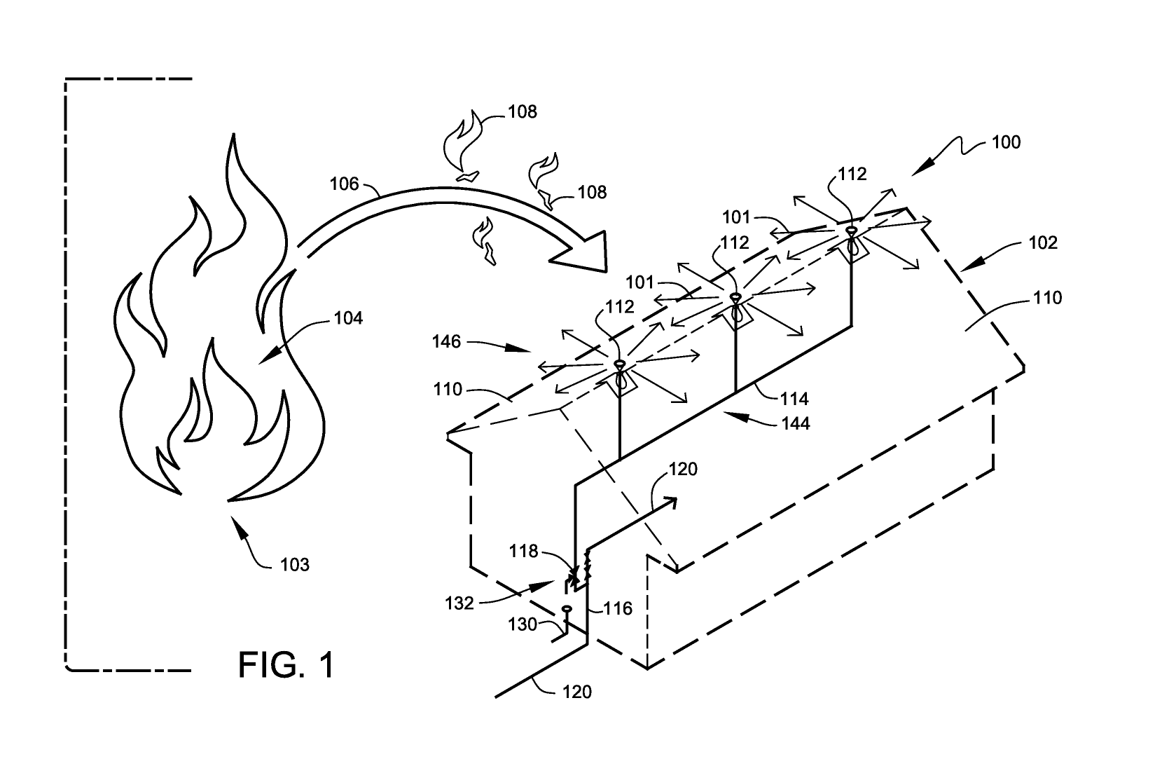

Referring now more specifically to the drawings by numerals of reference there is shown in FIGS. 1-8, various views of fire-suppression system 100. FIG. 1 shows a diagrammatic perspective view, illustrating fire-suppression system 100 during an ‘in-use’ condition. In the depiction of FIG. 1, building 102 is located in proximity of a large fire event 104, such as a forest fire. It is common in such events for thermal convection currents 106 to carry flaming debris 108 well beyond the burn zone 103 to deposit such debris 108 on roof surfaces 110 of adjacent buildings 102, as shown. As previously noted, many structures burn to the ground after flaming debris 108 contacts combustible roof materials or accumulations of leaves or needles on roof surface 110. Thus, building 102 is at risk even when located outside the direct path of fire event 104.

Fire-suppression system 100 is preferably designed to mitigate the risk to building 102 by dispersing water 101, or other fire-extinguishing agent, over roof surface 110, as shown. In the depicted embodiment of FIG. 1, water 101 is discharged from one or more exterior sprinkler heads 112 located on the rooftop peaks, as shown. In the present disclosure, sprinkler heads 112 embody herein at least one fluid disperser.

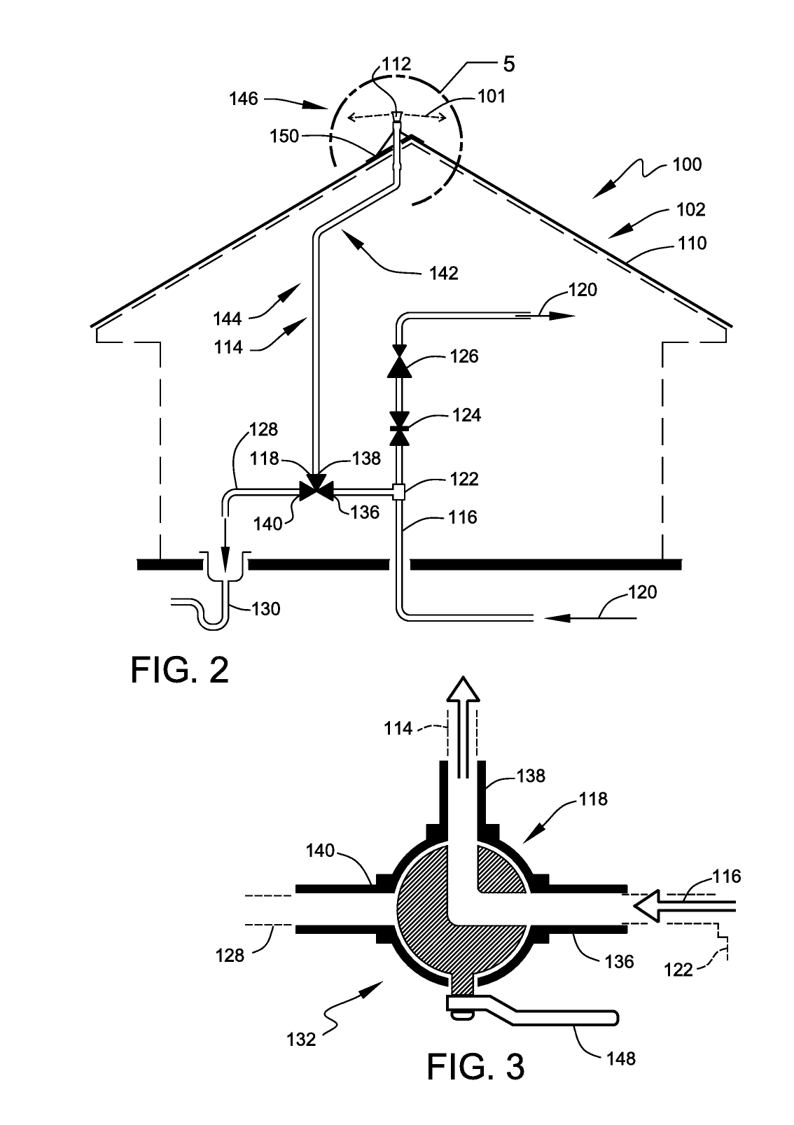

FIG. 2 is a diagram, further illustrating fire-suppression system 100 operably incorporated into building 102, according to the preferred embodiment of FIG. 1. Fire-suppression system 100 preferably operates as a manually-activated deluge system employing open sprinkler heads 112 attached to a water-conducting pipe assembly 114 connected to a pressurized water source 116 through a specially-configured control valve 118 that is opened by the operator. When control valve 118 opens, water flows into the water-conducting pipe assembly 114 and discharges from all sprinkler heads 112 attached thereto.

In most applications of the present system, the building's potable water supply 120 is used as the pressurized water source 116. In this preferred arrangement, the water-conducting pipe assembly 114 is coupled to the building's potable water supply 120 using an appropriately-compatible coupler fitting 122. In the present disclosure, the water-conducting pipe assembly 114 embodies herein at least one fluid conductor. Coupler fitting 122 preferably joins the building's potable water supply 120 upstream of the main shut-off valve 124 and pressure-reducing valve 126, as shown. Coupler fittings 122 suitable for use in the present system may include tee-fittings, and the like. Upon reading this specification, it should be appreciated that, under appropriate circumstances, considering such issues as design preference, code requirements, requirements of the local authorities having jurisdiction, etc., other device arrangements such as, for example, providing a backflow prevention device between the fire sprinkler system and potable water supply, providing a flow-switch alarm to indicate operational status, providing a booster pump to increase discharge pressure at the sprinkler heads, utilizing grey water or other non-potable water source, utilizing alternate chemical fire-suppression agents supplied from pressurized storage tanks, etc., may be sufficient.

A key feature of the present system is the novel implementation of control valve 118 used to control movement of water between the pressurized water source 116 (accessed at coupler fitting 122), the set of rooftop sprinkler heads 112, and a discharge drain line 128 placed in fluid communication with control valve 118. Discharge drain line 128 is preferably provided to enable draining of water from the portion of the water-conducting pipe assembly 114 extending between sprinkler heads 112 and control valve 118, as shown. Discharge drain line 128 may extend to the exterior of building 102, or may discharge into an interior floor sink 130 or similar drain, as shown.

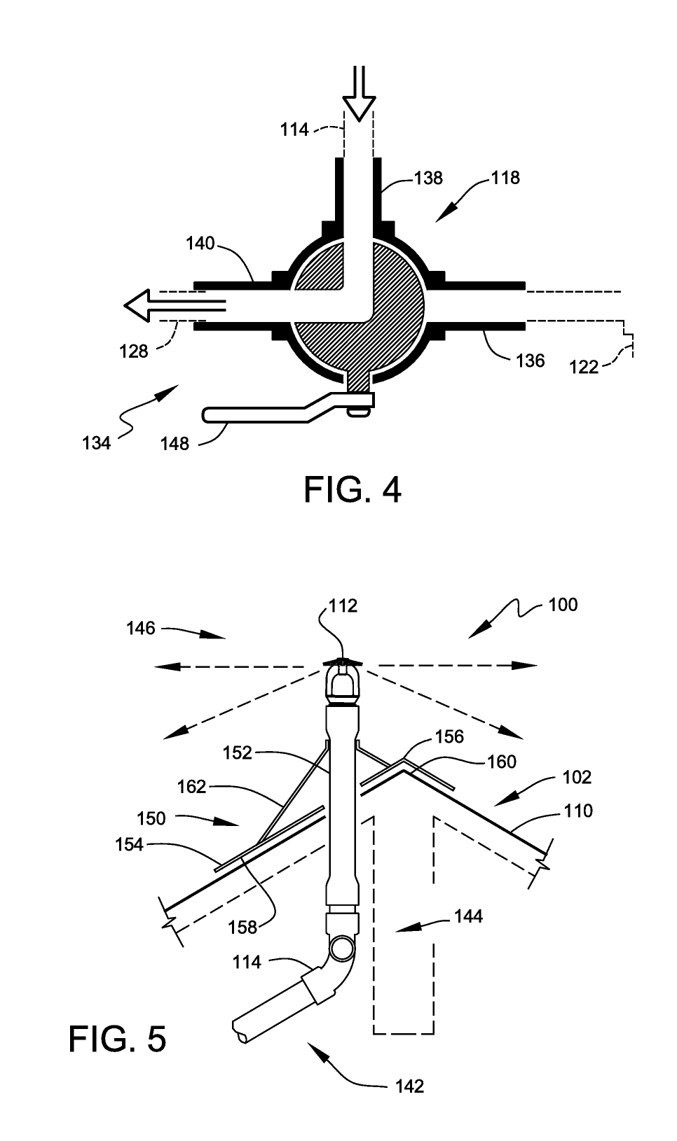

FIG. 3 is a diagram, illustrating control valve 118 adjusted to a first user-selectable configuration 132, according to the preferred embodiment of FIG. 1. FIG. 4 is a second diagram, illustrating control valve 118 adjusted to a second user-selectable configuration 134, according to the embodiment of FIG. 1. Reference is now made to FIG. 3 and FIG. 4, with continued reference to FIG. 1 and FIG. 2.

Control valve 118 preferably comprises a manually-operated three-way valve, as shown. A first port 136 of control valve 118 is placed in fluid communication with coupler fitting 122 (see also FIG. 2) and pressurized water source 116, as shown. A second port 138 of control valve 118 is placed in fluid communication with water-conducting pipe assembly 114 and the rooftop sprinkler heads 112 (see also FIG. 2). A third port 140 of control valve 118 is placed fluid communication with discharge drain line 128, as shown.

Control valve 118 is manually adjustable between the first user-selectable configuration 132 shown in FIG. 3 and second user-selectable configuration 134 shown in FIG. 4. More specifically, the first user-selectable configuration 132 of control valve 118 enables movement of water between coupler fitting 122 (and pressurized water source 116) and the set of rooftop sprinklers heads 112 while preventing the movement of water to discharge drain line 128. When control valve 118 is adjusted to the first user-selectable configuration 132, fire-suppression system 100 is activated and water from pressurized water source 116 is transported through water-conducting pipe assembly 114 to discharge at the set of sprinkler heads 112 (see also FIG. 1). At the same time, the system is preferably configured to block the movement of water to discharge drain line 128. This cotemporaneous operation can be implemented by a single user performing a single manipulation of a single control valve 118.

Referring to again to FIG. 4, the second user-selectable configuration 134 of control valve 118 prevents movement of water between coupler fitting 122 (and pressurized water source 116) and sprinkler heads 112 while at the same time enabling the movement of water from water-conducting pipe assembly 114 to discharge drain line 128. When control valve 118 is adjusted to the second user-selectable configuration 134, fire-suppression system 100 is de-activated and any water present within water-conducting pipe assembly 114 (above control valve 118) drains from the system through discharge drain line 128, as shown. This cotemporaneous operation can also be implemented by a single user performing a single manipulation of a single control valve 118.

Referring again to FIG. 2, the water-conducting pipe of water-conducting pipe assembly 114 is preferably installed with a sloping geometry 142 to enable gravity-assisted drainage of the water through discharge drain line 128 when control valve 118 is placed in second user-selectable configuration 134. Preferably, at least one sprinkler head 112 of the set of rooftop sprinkler heads 112 is vented to atmosphere to facilitate drainage when the system is deactivated. This further facilitates the essentially automatic draining of all water from the pipes located above control valve 118 when the valve is placed in second user-selectable configuration 134 and the system is deactivated. The above-described automatic purging of the sprinkler piping on deactivation effectively prevents pipe failures due to freezing, which often occur in prior continuously-pressurized systems.

Fire-suppression system 100 includes both interior-located system components 144 and exterior-located system components 146, as shown in FIG. 2. Exterior-located system components 146 are located outside of building 102 and include the set of roof-mounted sprinkler heads 112. Interior-located system components 144 generally include the water-conducting pipe, control valve 118, and coupler fitting 122. The three-way control valve 118 is preferably installed in a heated space, preferably within or beside building 102. To assist operator accessibility, the manual actuation lever 148 of control valve 118 (see also FIG. 3 and FIG. 4) is preferably installed in a user-accessible space and may be located at an elevation between about 48 inches (1200 mm) and about 42 inches (1067 mm) above the floor, or in accordance with governing codes. It should be noted that control valve 118 may alternatively be supplied as an electrically-actuated valve that is activated remotely by a municipality, a fire department, or other authority having jurisdiction. Upon reading this specification, it should be appreciated that, under appropriate circumstances, considering such issues as user preferences, design preference, code requirements, marketing preferences, cost, available materials, technological advances, etc., other valve control arrangements such as, for example, providing an electrically-actuated valve operated by other remotely-generated signals, utilizing an electrically-actuated valve capable of remote actuation via a user's mobile device or a web interface, etc., may be sufficient.

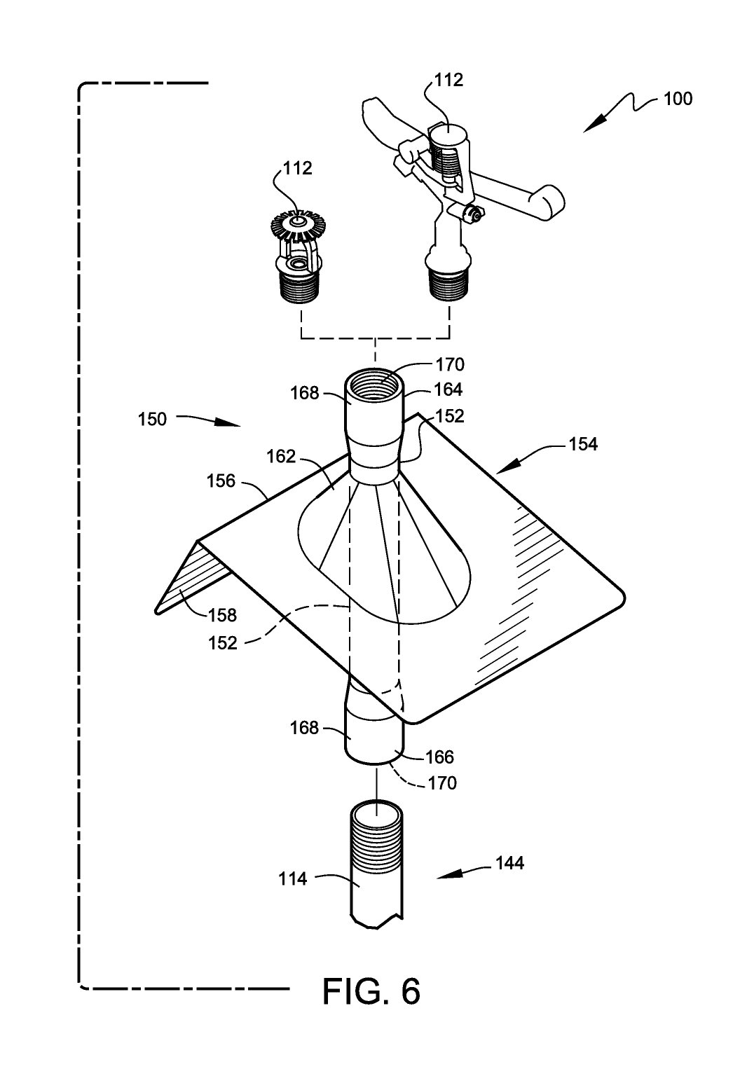

In addition, fire-suppression system 100 further comprises a set of pre-assembled interior-to-exterior fluid coupler and flashing assemblies 150, each one configured to operably couple a respective interior-located system component 144 with a respective sprinkler head 112 or other exterior-located system component 146. Such interior-to-exterior fluid coupler and flashing assemblies 150 are described in greater detail in FIG. 5 and FIG. 6, below.

FIG. 5 is the detail section view 5 of FIG. 2, magnified for clarity, illustrating a pre-assembled interior-to-exterior fluid coupler and flashing assembly 150 installed on roof surface 110 of building 102, according to an embodiment of the present disclosure. FIG. 6 shows an exploded perspective view, illustrating the pre-assembled interior-to-exterior fluid coupler and flashing assembly 150, according to the embodiment of FIG. 3.

Each interior-to-exterior fluid coupler and flashing assembly 150 preferably includes, fluid-conducting pipe segment 152 to conduct water through roof surface 110, and joined integrally with and surrounding fluid-conducting pipe segment 152, a flashing member 154 adapted to be attached and sealed to roof surface 110 to prevent moisture leakage around the assembly and through roof surface 110. It is envisioned that flashing member 154 will be supplied in a wide range of configurations to fit roofs of differing slopes. In one preferred embodiment of the system, flashing member 154 includes a folded peak 156 to facilitate attachment and sealing of base surface 158 to a peak portion 160 of roof surface 110, as shown. Preferred embodiments of interior-to-exterior fluid coupler and flashing assembly 150 may optionally include a generally frustoconical collar 162 extending up from flashing member 154 and surrounding the upper portion of fluid-conducting pipe segment 152, as shown. Such collars 162 may be configured to maintain a complete seal with fluid-conducting pipe segment 152 during and after thermal expansion and contraction cycling.

Although interior-to-exterior fluid coupler and flashing assembly 150 is a unique apparatus, flashing member 154 is configured to assist installation to roof surface 110 using customary methods known in the art. Thus, the generally-planar flashing member 154 may be configured enable portions of the member to extend underneath adjacent roof shingles or other roofing materials (not shown). Moreover, base surface 158 of flashing member 154 may be configured to assist in sealing the member to roof surface 110 using a mastic or similar roofing compound. In addition, flashing member 154 may be configured to assist in the mechanical fastening of the assembly to roof surface 110, etc.

Interior-to-exterior fluid coupler and flashing assembly 150 may be constructed from a wide variety of materials, which would be expected to provide long-term protection against rain and weather while harmonizing visually with the materials of the roof coverings. Flashing member 154 is preferably made of a preformed material such as, but not limited to, sheet metal, plastic, or a hard synthetic rubber. Interior-to-exterior fluid coupler and flashing assembly 150 is preferably supplied pre-assembled in a factory-applied finish. Upon reading this specification, it should be appreciated that, under appropriate circumstances, considering such issues as design preference, user preferences, marketing preferences, cost, structural requirements, available materials, technological advances, etc., other flashing arrangements such as, for example, including more or fewer flashing components, using alternate flashing shapes, alternate flange sizes, alternate flashing materials, locating the pipe in an alternate position within the flashing member, etc., may be sufficient.

In specific reference to FIG. 6, each fluid-conducting pipe segment 152 includes an exterior-end coupler 164 adapted to form a fluid-tight coupling with at least one sprinkler head 112 or other exterior-located system component. Each fluid-conducting pipe segment 152 further includes an interior-end coupler 166 adapted to form a fluid-tight coupling with water-conducting pipe assembly 114 or other interior-located system component 144. In one preferred embodiment of the present system, exterior-end coupler 164 includes a cylindrical wall 168 having an internally-threaded bore 170, as shown. In this arrangement, internally-threaded bore 170 provides an industry-standard female iron pipe (FIP) thread configuration. This preferred arrangement enables the use of a wide range of commercially-available sprinkler heads 112 having a MIP fitting, as shown. Two example sprinkler heads 112 having a MIP fittings are shown; however, it should be noted that many other sprinkler head configurations may be used with the present embodiment. Alternately preferably, exterior-end coupler 164 may be adapted to receive other industry-standard pipe-fittings, as required by the installation. Alternately preferably, exterior-end coupler 164 may be adapted to receive a proprietary fitting. Upon reading this specification, it should be appreciated that, under appropriate circumstances, considering such issues as user preferences, design preference, code marketing preferences, cost, available materials, technological advances, etc., other sprinkler head arrangements such as, for example, providing fluid-conducting pipe segments having integral sprinkler heads, concealing portions of the sprinkler head with additional shrouding, utilizing concealed “pop-up” style sprinkler heads, etc., may be sufficient.

Interior-end coupler of fluid-conducting pipe segment 152 is also adapted to receive an industry-standard pipe-fitting, as shown. In one preferred embodiment of the present system interior-end coupler 166 also includes a cylindrical wall 168 having an internally-threaded bore 170 (similar in arrangements to exterior-end coupler 164). In this arrangement, internally-threaded bore 170 provides an industry-standard female iron pipe (FIP) thread configuration. This preferred arrangement enables the use of a wide range of commercially-available fitting and adapter fittings having MIP fittings, as shown. Alternately preferably, interior-end coupler 166 may be adapted to directly receive other industry-standard pipe-fittings such as those designed for PEX supply piping, etc. Alternately preferably, interior-end coupler 166 may be adapted to receive a proprietary fitting.

The water-conducting pipe or tubing of water-conducting pipe assembly 114 may be constructed from one or more durable materials suitable for the transport of water within a building or structure. Such pipe or tubing forming the water-conducting pipe assembly 114 preferably comprises at least one material selected from steel, cast iron, copper, Chlorinated Polyvinyl Chloride (CPVC), Polyvinyl Chloride (PVC), and Crosslinked Polyethylene (PEX) or combinations thereof. It is noted that PEX is both compatible with the preferred arrangements of the present system and is often used in residential plumbing. PEX is generally accepted by most authorities having jurisdiction, is relatively fast to install, and those skilled in the art of plumbing generally have the tools and the knowledge required to install a PEX-base version of the present system.

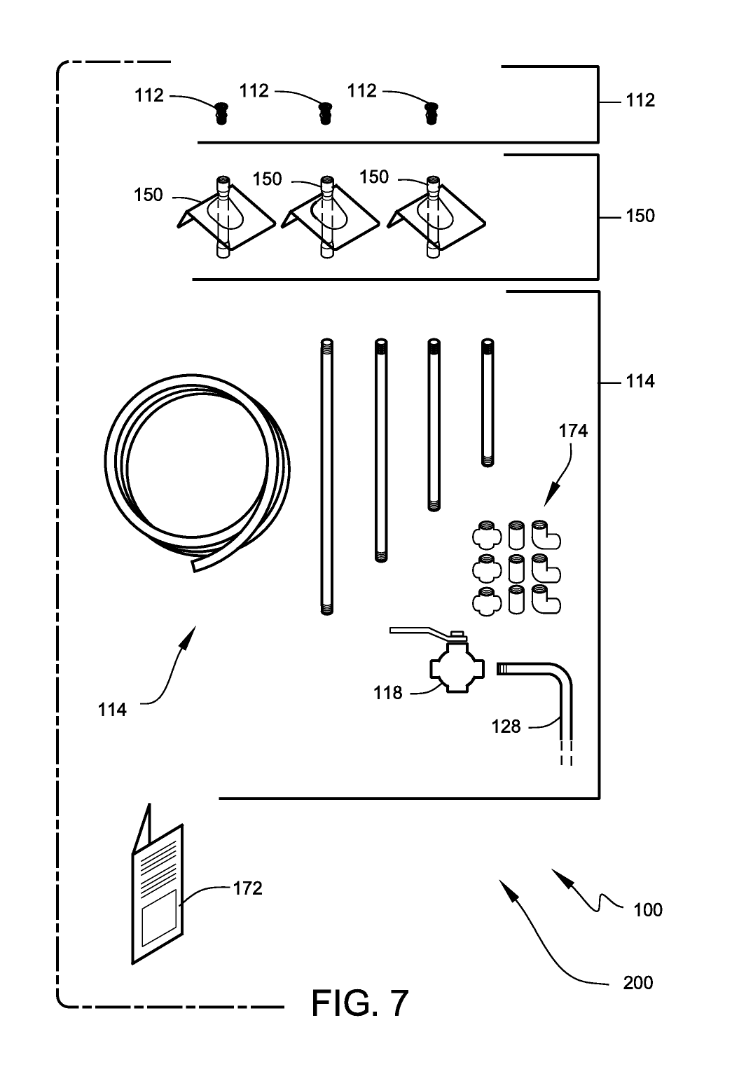

FIG. 7 is a diagram, illustrating components of kit 200, according to another preferred embodiment of the disclosure. Fire-suppression system 100 may be sold as a kit comprising the following parts: a set of sprinkler heads 112, a set of interior-to-exterior fluid coupler and flashing assemblies 150, water-conducting pipe assembly 114 including control valve 118 and discharge drain line 128, and a set of user instructions 172. User instructions 172 of kit 200 are arranged and presented such that functional relationships are detailed in relation to the structure of the invention (such that the invention can be used, maintained, or the like in a preferred manner). Water-conducting pipe assembly 114 may comprise rigid pipe segments, flexible rolls of tubing, or combinations of both, as required by an installation. Kit 200 may further comprise one or more miscellaneous fittings 174, as required to complete an installation.

Fire-suppression system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

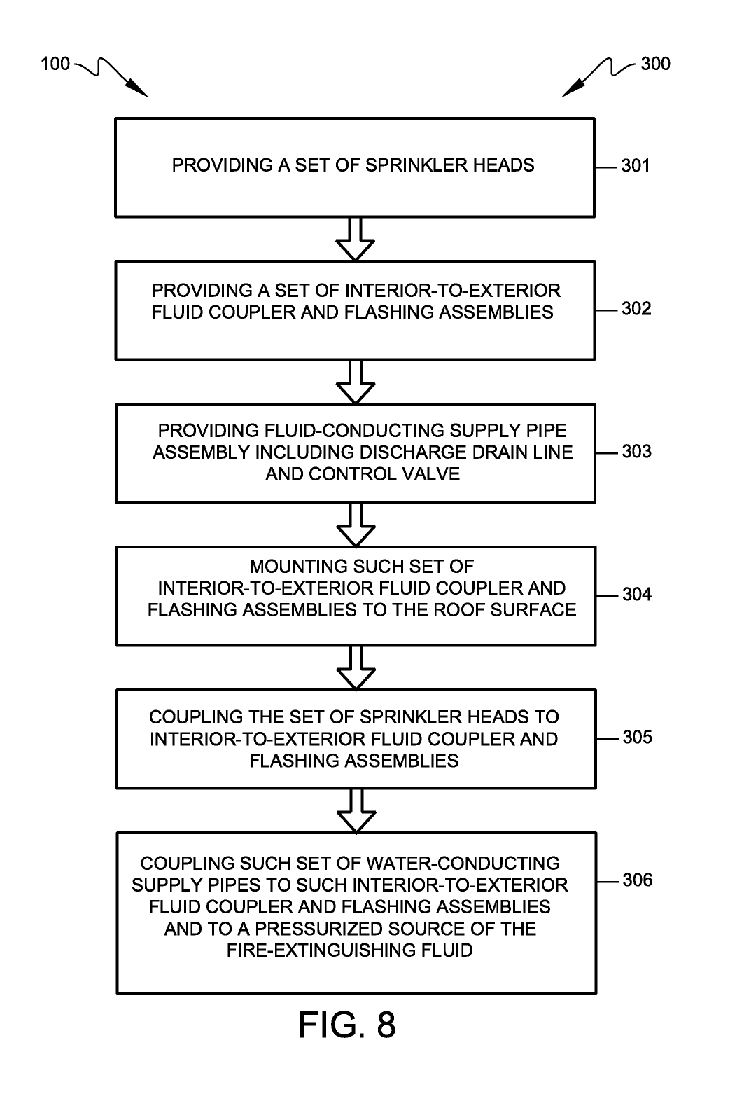

Referring now to FIG. 8 showing a flow diagram illustrating method of use 300 for Fire-suppression system 100 according to an embodiment of the present invention of FIGS. 1-7. As shown, method of use 300 may comprise the steps of: step one 301, providing a set of sprinkler heads 112; step two 302, providing a set of interior-to-exterior fluid couplers and flashing assemblies 150; and step three 303, providing fluid-conducting supply pipe assembly 114 including discharge drain line 128, and control valve 118.

Furthermore, method of use 300 includes the additional steps of: step four 304, mounting such set of interior-to-exterior fluid coupler and flashing assemblies 150 to the roof surface; step five 305, coupling the set of sprinkler heads 112 to such interior-to-exterior fluid coupler and flashing assemblies 150; step six 306, coupling such set of water-conducting supply piping 114 to such interior-to-exterior fluid coupler and flashing assemblies 150 and to a pressurized source of the at least one fire-extinguishing fluid; whereby, protection of roof surface 110 of building 102 using the at least one fire-extinguishing agent is provided.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fire-suppression system, relating to protection of at least one roof surface of a building using at least one fire-extinguishing fluid, said fire-suppression system comprising:
a. at least one fluid disperser configured to assist dispersal of said at least one fire-extinguishing fluid over at least one portion of said at least one roof surface; and
b. in fluid communication with said at least one fluid disperser, at least one fluid conductor configured to conduct said fire-extinguishing fluid to said at least one fluid disperser;
c. wherein said at least one fluid conductor comprises
i. at least one fluid coupler configured to operably couple said at least one fluid conductor with at least one pressurized source of said at least one fire-extinguishing fluid,
ii. at least one discharge drain configured to enable draining of said at least one fire-extinguishing fluid from at least one portion of said at least one fluid conductor, and
iii. a fluid control valve configured to control movement of such at least one fire-extinguishing fluid between said at least one fluid coupler, said at least one fluid disperser, and said at least one discharge drain;
d. wherein said fluid control valve comprises a first user-selectable configuration and a second user-selectable configuration;
e. wherein said first user-selectable configuration enables movement of said at least one fire-extinguishing fluid between said at least one fluid coupler and said at least one fluid disperser while contemporaneously preventing draining of said at least one fire-extinguishing fluid from said at least one portion of said at least one fluid conductor through said at least one discharge drain;
f. wherein said second user-selectable configuration of said fluid control valve prevents movement of said at least one fire-extinguishing fluid between said at least one fluid coupler and said at least one fluid disperser while contemporaneously enabling draining of said at least one fire-extinguishing fluid from said at least one portion of said at least one fluid conductor through said at least one discharge drain; and
g. wherein, when said fluid control valve is placed in said first user-selectable configuration, such dispersal of such fire-extinguishing fluid on said at least one portion of such at least one roof surface is enabled.

2. The fire-suppression system of claim 1 wherein said fluid control valve comprises a three-way valve.

3. The fire-suppression system of claim 1 wherein:
a. said fire-extinguishing fluid comprises water;
b. said at least one portion of said at least one fluid conductor comprises at least one water-conducting pipe operably coupling said fluid control valve and said at least one fluid disperser; and
c. said at least one water-conducting pipe comprises at least one sloping geometry configured to enable gravity-assisted drainage of said water through said at least one discharge drain when said fluid control valve is placed in said second user-selectable configuration.

4. The fire-suppression system of claim 3 wherein:
a. said at least one fluid disperser is vented to atmosphere; and
b. said fluid control valve is configured to place said at least one fluid disperser in fluid communication with said at least one discharge drain when said fluid control valve is placed in said second user-selectable configuration.

5. The fire-suppression system of claim 3 wherein said at least one water-conducting pipe comprises at least one material selected from the group consisting of steel, cast iron, copper, Chlorinated Polyvinyl Chloride, Polyvinyl Chloride, and Crosslinked Polyethylene.

6. The fire-suppression system of claim 3 wherein said at least one fluid disperser comprises at least one commercially-sourced sprinkler head.

7. The fire-suppression system of claim 3 further comprising at least one floor drain to receive water discharged from said at least one portion of said at least one water-conducting pipe.

8. The fire-suppression system of claim 3 further comprising:
a. interior-located system components located interior of such at least one building; and
b. exterior-located system components located exterior of such at least one building;
c. wherein said at least one fluid disperser comprises at least one of said exterior-located system components; and
d. wherein at least one of said fluid control valve and said at least one water-conducting pipe comprise said interior-located system components.

9. The fire-suppression system of claim 8 further comprising:
a. a set of interior-to-exterior fluid couplers, each one configured to operably couple said interior-located system components with said exterior-located system components;
b. wherein each said interior-to-exterior fluid coupler comprises
i. at least one fluid-conducting pipe segment configured to conduct water through such at least one roof surface, and
ii. joined integrally with and surrounding said at least one fluid-conducting pipe segment, at least one flashing member having a base surface configured to be attached and sealed to such at least one roof surface to prevent moisture leakage therethrough.

10. The fire-suppression system of claim 9 wherein said base surface of said flashing member is configured to be attached and sealed to at least one peak portion of such at least one roof surface.

11. The fire-suppression system of claim 9 wherein said at least one interior-to-exterior fluid coupler comprises at least one factory applied finish.

12. The fire-suppression system of claim 9 wherein said at least one fluid-conducting pipe segment comprises:
a. at least one exterior-end coupler configured to form a fluid-tight coupling with at least one of said exterior-located system components; and
b. at least one interior-end coupler configured to form a fluid-tight coupling with at least one of said interior-located system components.

13. The fire-suppression system of claim 12 wherein said at least one exterior-end coupler comprises a cylindrical wall having an internally-threaded bore.

14. The fire-suppression system of claim 13 wherein said internally-threaded bore comprises an industry-standard female iron pipe thread configuration.

15. The fire-suppression system of claim 12 wherein said at least one interior-end coupler comprises an industry-standard female iron pipe thread configuration.

16. The fire-suppression system of claim 12 wherein said at least one interior-end coupler is adapted to receive at least one industry-standard pipe-fitting.

17. A fire-suppression system, relating to protection of a roof surface of a building using water as a fire-extinguishing agent, said fire-suppression system comprising:
a. a set of sprinklers configured to assist dispersal of said water on a portion of said roof surface; and
b. in fluid communication with said set of sprinklers, at least one water-conducting pipe configured to conduct said water to said set of sprinklers;
c. wherein said at least one water-conducting pipe comprises
i. a fluid coupler configured to operably couple said at least one water-conducting pipe with a pressurized source of said water,
ii. a discharge drain configured to enable draining of such water from a portion of said at least one water-conducting pipe, and
iii. a fluid control valve configured to control movement of said water between said fluid coupler, said set of sprinklers, and said discharge drain;
d. wherein said fluid control valve comprises a first user-selectable configuration and a second user-selectable configuration;
e. wherein said first user-selectable configuration of said fluid control valve enables movement of said water between said fluid coupler and said set of sprinklers while contemporaneously preventing draining of such water from said portion of said at least one water-conducting pipe through said discharge drain;
f. wherein said second user-selectable configuration of said fluid control valve prevents movement of said water between said fluid coupler and said set of sprinklers while contemporaneously enabling draining of said water from said portion of said at least one water-conducting pipe through said discharge drain;
g. wherein, when said fluid control valve is placed in said first user-selectable configuration, such dispersal of such water on such portion of such roof surface is enabled;
h. wherein said fluid control valve comprises a three-way valve;
i. wherein said water-conducting pipe comprises a sloping geometry configured to enable gravity-assisted drainage of said water through said discharge drain when said fluid control valve is placed in such second user-selectable configuration;
j. wherein at least one sprinkler of said set of sprinklers is vented to atmosphere;
k. wherein said water-conducting pipe, including said fluid control valve, are configured to place said at least one sprinkler in fluid communication with said discharge drain when said fluid control valve is placed in said second user-selectable configuration;
l. wherein said water-conducting pipe comprises at least one material selected from steel, cast iron, copper, Chlorinated Polyvinyl Chloride, Polyvinyl Chloride, and Crosslinked Polyethylene;
m. wherein said set of sprinklers comprise at least one commercially-sourced sprinkler head;
n. wherein said fire-suppression system further comprises interior-located system components located interior of said building and exterior-located system components located exterior of said building;
o. wherein said set of sprinklers comprise said exterior-located system components;
p. wherein said water-conducting pipe comprises said interior-located system components;
q. wherein said fire-suppression system further comprises a set of interior-to-exterior fluid couplers, each one configured to operably couple a respective said interior-located system component with a respective said exterior-located system component;
r. wherein each said interior-to-exterior fluid coupler comprises,
i. a fluid-conducting pipe segment configured to conduct water through said roof surface, and
ii. joined integrally with and surrounding said fluid-conducting pipe segment, a flashing member having a base surface configured to be attached and sealed to such roof surface to prevent moisture leakage therethrough;
s. wherein said base surface of said flashing member is configured to be attached and sealed to a peak portion of said roof surface;
t. wherein said interior-to-exterior fluid coupler comprises a factory applied finish;
u. wherein said fluid-conducting pipe segment comprises an exterior-end coupler configured to form a fluid-tight coupling with exterior-located system components and an interior-end coupler adapted to form a fluid-tight coupling with interior-located system components;
v. wherein said exterior-end coupler comprises a cylindrical wall having an internally-threaded bore;
w. wherein said internally-threaded bore comprises an industry-standard female iron pipe thread configuration; and
x. wherein said interior-end coupler is configured to receive an industry-standard pipe-fitting.

18. The fire-suppression system of claim 17 further comprising a kit including:
a. said set of sprinklers;
b. said set of interior-to-exterior fluid couplers;
c. said water-conducting pipe including said fluid control valve and said discharge drain; and
d. a set of user instructions.

19. A method of using a fire-suppression system, relating to protection of a roof surface of a building using at least one fire-extinguishing fluid, said method comprising the steps of:
a. providing a set of sprinklers;
b. providing a set of interior-to-exterior fluid couplers, each one including
i. a fluid-conducting pipe segment configured to conduct such at least one fire-extinguishing fluid through said roof surface, and
ii. joined integrally with and surrounding said fluid-conducting pipe segment, a flashing member having a base surface configured to be attached and sealed to the roof surface to prevent moisture leakage therethrough;
c. providing a set of fluid-conducting pipes including
i. a discharge drain, and
ii. a manually-operable control valve configured to activate said system and automatically drain such at least one fire-extinguishing fluid from said set of fluid-conducting pipes on deactivation of said system.

20. The method of a fire-suppression system of claim 19 further comprising the steps of
a. mounting such interior-to-exterior fluid couplers to said roof surface;
b. coupling said set of sprinklers to such interior-to-exterior fluid couplers; and
c. coupling such set of water-conducting pipes to said interior-to-exterior fluid couplers and to a pressurized source of said at least one fire-extinguishing fluid;
d. whereby protection of said roof surface of said building using said at least one fire-extinguishing fluid is provided.
